(19) United States
(12) Patent Application Publication
(10) Pub. No.: US 2025/0210297 A1
(43) Pub. Date: Jun. 26, 2025

(54) ELECTRICAL CIRCUIT EQUIPPED WITH TWO PYROTECHNIC SWITCHES ALLOWING TO ELECTRICALLY ISOLATE A SECTION WHEN A SHORT-CIRCUIT TYPE FAULT OCCURS

(71) Applicant: SAFRAN ELECTRICAL & POWER, Blagnac Cedex (FR)

(72) Inventors: Eric GUILLARD, MOISSY CRAMAYEL (FR); Guillaume PORTE, MOISSY CRAMAYEL (FR)

(73) Assignee: SAFRAN ELECTRICAL & POWER, Blagnac Cedex (FR)

(21) Appl. No.: 18/990,275

(22) Filed: Dec. 20, 2024

(30) Foreign Application Priority Data
Dec. 22, 2023 (FR) 23/15172

(51) Int. Cl. H01H 85/055; B64D 33/00

(52) U.S. Cl. CPC H01H 85/055; B64D 33/00

(57) ABSTRACT

An electrical circuit of an aircraft including a power supply electrically connected to an electric charge by a conductive element, and a main electrical protection element. The electrical circuit includes a first pyrotechnic switch provided with at least one first initiator element and at least one first mechanical cut-off element, and a second pyrotechnic switch provided with at least one second initiator element and at least one second mechanical cut-off element. The first initiator element and the second initiator element are each electrically positioned in parallel with the at least one main electrical protection element.

### CROSS-REFERENCE TO RELATED APPLICATIONS

This application claims priority to and the benefit of FR 23/15172 filed on Dec. 22, 2023. The disclosure of the above application is incorporated herein by reference.

### FIELD

The present disclosure relates to the field of electrical circuits and more particularly an electrical circuit for supplying at least one electric charge of an aircraft.

### BACKGROUND

The statements in this section merely provide background information related to the present disclosure and may not constitute prior art.

In this disclosure, the term “aircraft” designates a set of appliances capable of navigating in the air, such as for example conventional aircraft also designated by the acronym CTOL (Convention Take Off and Landing), vertical take off and landing craft designated by the acronym VTOL (vertical take off and landing), and short take off and landing craft designated by the acronym STOL.

It is known that aircraft comprise an electric charge, that is to say a device that consumes electricity during normal operation. For example, the electric load may be an electric propulsion comprising at least one electric motor.

The electric propulsion is powered by an electric circuit providing a high-voltage direct current, for example greater than 800 V.

It is known that the electric circuit comprises at least one power supply, at least one distribution box and at least one distribution harness.

The power supply corresponds to an electric generator such as a battery.

The distribution box comprises at least one switching element, for example a contactor, allowing to switch on or off the distribution harness and therefore ultimately the electric propulsion.

The distribution harness, comprising at least one conductive element such as an electric cable, carries the electrical energy from the distribution box to the electric propulsion.

In the remainder of the description, the upstream and the downstream are defined relative to a normal supply direction of the electric load (from upstream to downstream), that is to say from the power supply to the electric load.

Finally, the electrical circuit is electrically protected in the case of a short-circuit fault by at least one electrical protection such as a fuse. This electrical protection can be positioned, for example, at the distribution box, downstream of the switching element and upstream of the distribution harness.

An arrangement of the different elements of the electrical circuit is called the architecture of the electrical circuit.

With such an architecture, when a short-circuit fault appears in the distribution harness, the electrical protection makes it possible to cut an electrical link between the power supply and the electric propulsion, so as to protect the distribution harness against a degradation linked to the fault.

However, when the electric charge is reversible, it can then become a generator and re-supply the short-circuit fault. This is particularly true when the electric charge is an electric motor. In this case, the re-supply of the electrical fault by the electric motor which becomes a generator is also called the windmilling effect.

The re-supply of the short-circuit electrical fault may present an issue for the aircraft.

To avoid re-supplying the short-circuit fault as described above, an additional electrical protection must be added between the distribution harness and the electric charge. This additional electrical protection must be fast and as non-dissipative as possible. Finally, a physical integration of this additional electrical protection in the aircraft also presents difficulties.

### SUMMARY

This section provides a general summary of the disclosure and is not a comprehensive disclosure of its full scope or all of its features.

The present disclosure therefore aims to propose an architecture of an electrical circuit for supplying an electric charge of an aircraft that makes it possible to avoid re-supplying a short-circuit type fault while being easily integrated into an aircraft.

An example concerns an electrical circuit for supplying at least one electric charge of an aircraft, the electrical circuit comprising at least one electrical power supply electrically connected to the at least one electric charge by means of at least one conductive element, and at least one main electrical protection element positioned between the at least one electrical power supply and an upstream point of a section of the at least one conductive element to be protected during the occurrence of an electrical fault, characterized in that the electrical circuit comprises at least one first pyrotechnic switch provided with at least one first initiator element and at least one first mechanical cut-off element which is configured to electrically cut-off the at least one conductive element between the at least one electrical power supply and the upstream point of the section to be protected, and at least one second pyrotechnic switch provided with at least one second initiator element and at least one second mechanical cut-off element which is configured to electrically cut-off the at least one conductive element between a downstream point of the section to be protected and the electric charge, the first initiator element and the second initiator element each being electrically positioned in parallel with the at least one main electrical protection element.

The at least one electric charge corresponds to a device consuming electricity in normal operation. For example, the electric charge may be an electric propulsion comprising at least one electric motor to be powered by a high-voltage direct current, for example greater than 800 Vdc.

The electrical power supply is an element that supplies electrical energy to the electrical circuit. The electrical power supply comprises an electrical generator such as a battery.

The conductive element is configured to circulate an electric current allowing to electrically power the electric charge. The conductive element comprises a section to be protected when an electrical fault occurs, for example of the short-circuit type. In other words, it is a section that must be electrically isolated following the occurrence of the electrical fault in the section. The section is comprised between an upstream point and a downstream point.

In the remainder of the description, the upstream and the downstream are defined relative to a normal supply direction of the electric charge (from upstream to downstream), that is to say from the electrical supply to the electric charge.

The main electrical protection element is configured, in an engaged state, to pass the electrical current enabling the electric charge to be electrically supplied, and to be in a triggered state when an electrical fault occurs in the section to be protected of the conductive element. The engaged state is the state of the main electrical protection element during normal operation of the electrical circuit. The positioning of the main electrical protection element between the electrical supply and the upstream point of the section to be protected allows the main electrical protection element to be subjected to the short-circuit current. The main electrical protection element is in the triggered state when the electrical current at its terminals is greater than a maximum electrical current.

The pyrotechnic switches can be in a closed state in which they allow the electric current to pass through the conductive element, or in an open state in which the electric current can no longer pass through the conductive element. The closed state is the state of the pyrotechnic switches during normal operation of the electrical circuit. The pyrotechnic switches are only in an open state when an electrical fault occurs.

The pyrotechnic switches each comprise an initiator element and a mechanical cut-off element.

The pyrotechnic charge controlled by the initiator element is in a nominal state as long as an electrical voltage at its terminals is lower than a triggering voltage. The nominal state is the state of the initiator element during normal operation of the electrical circuit. The pyrotechnic charge controlled by the initiator element is in a triggered state when the voltage at its terminals has become greater than or equal to the triggering voltage for at least one instant, such as when the electrical fault occurs. A certain duration, called the trigger response time, is desired for the initiator element to change from the nominal state to the triggered state.

In some examples, the triggering voltage of the first initiator element is equal to the triggering voltage of the second initiator element.

The mechanical cut-off element is a movable element, for example in translation, configured to perform an electrical cut-off of the conductive element. The mechanical cut-off element may be in a nominal state or in an actuated state. The nominal state is the state of the mechanical cut-off element during normal operation of the electrical circuit. The mechanical cut-off element is in an actuated state when the initiator element has moved to a triggered state. It takes a certain duration, called the mechanical response time, for the mechanical cut-off element to move from the nominal state to the actuated state. The mechanical cut-off element cuts the conductive element at the positioning of the pyrotechnic switch. In other words, since the first mechanical cut-off element cuts the conductive element between the power supply and the upstream point of the section to be protected, the first pyrotechnic switch is positioned between the power supply and the upstream point of the section to be protected, and since the second mechanical cut-off element cuts the conductive element between the downstream point of the section to be protected and the electric charge, the second pyrotechnic switch is positioned between the downstream point of the section to be protected and the electric charge.

The first switch and the second switch are mechanically positioned in series along the conductive element. This electrical positioning makes it possible to increase the cut-off capacity of each pyrotechnic switch so that the first pyrotechnic switch and the second pyrotechnic switch can be dimensioned with an operating voltage corresponding to half the voltage of the electrical supply that is applied to the electric charge.

When the pyrotechnic charge controlled by the initiator element is in the nominal state, the mechanical cut-off element is also in the nominal state and the pyrotechnic switch is in the closed state.

When the pyrotechnic charge controlled by the initiator element is in the triggered state, the mechanical cut-off element is in the actuated state and the pyrotechnic switch is in the open state.

The mechanical cut-off element is configured to break an electrical link at the positioning of the pyrotechnic switch in the electrical circuit, when the mechanical cut-off element is actuated by the initiator element.

In the electrical circuit according to the present disclosure, the first and second pyrotechnic switches are configured to cut the conductive element between the power supply and the electric charge when an electrical fault occurs so as to isolate the section to be protected. More particularly, the first pyrotechnic switch is configured to cut the conductive element between the power supply and the upstream point of the section to be protected, while the second pyrotechnic switch is configured to cut the conductive element between the downstream point of the section to be protected and the electric charge.

As described above, the pyrotechnic switches are positioned in the open state when the voltage across the terminals of the initiator element has become greater than or equal to the triggering voltage of the pyrotechnic charge.

According to the present disclosure, the first initiator element and the second initiator element are each electrically positioned in parallel with the at least one main electrical protection element. Thus, the voltage across the first initiator element and the second initiator element is identical, and equal to the voltage across the main electrical protection element. So that if the voltage across the terminals of the main electrical protection element becomes greater than or equal to the triggering voltage of the pyrotechnic charge, the voltage across the terminals of the first initiator element and the second initiator element also becomes greater than or equal to the triggering voltage so that the first initiator element and the second initiator element switch to the triggered state, causing the first and second mechanical cut-off elements to switch to the actuated state, and finally the two pyrotechnic switches to switch to the open state. Thus, the electrical circuit according to the present disclosure does not comprise specific electronics for actuating the pyrotechnic switches. It is directly an overload current linked to the short circuit that induces the triggering of the pyrotechnic switches.

When an electrical fault occurs in the section to be protected, the main electrical protection element will detect an overload current and switch to the triggered state. At least when switching from the engaged state to the triggered state, an electric arc forms across the terminals of the main electrical protection element. The electric arc causes a voltage at the terminals of the main electrical protection element greater than or equal to the triggering voltage of the pyrotechnic switches, and therefore also at the terminals of the first initiator element and the second initiator element. The first initiator element and the second initiator element therefore switch to the triggered state, thereby activating the first and second mechanical cut-off elements which therefore switch to the actuated state. Finally, the first and second pyrotechnic switches are therefore in the open state. The section of the conductive element is therefore electrically separated from the electrical circuit, the electrical fault is therefore also isolated. There is no longer any possibility of re-supplying the electrical fault by the electric charge, that is to say even in the case of a windmilling effect.

The present disclosure may also have one or more of the following characteristics taken alone or in combination.

In certain examples, a response time of a triggering of the at least one first and at least one second initiator element are identical.

In some examples, a mechanical response time of the at least one first and at least one second mechanical cut-off element are identical.

In some examples, a response time of a triggering of the at least one first and at least one second initiator element is less than a mechanical response time of the at least one first and at least one second mechanical cut-off element.

When the electric arc is formed across the terminals of the main electrical protection element, even if the first initiator element receives the triggering voltage slightly before the second initiator element, the first mechanical cut-off element only switches to the actuated state when the second initiator element has received the triggering voltage. Thus, both initiator elements are triggered before one of the mechanical elements switches to the actuated state.

In some examples, the at least one first initiator element and/or the at least one second initiator element comprises at least one electrical resistor surrounded by a pyrotechnic powder or liquid.

Thus, when the electrical resistor receives a voltage greater than that of its triggering, the resistor heats up, creating an electric arc that powers the electrical resistor of the initiator, leading to the triggering of the pyrotechnic powder or liquid.

In some examples, the at least one first mechanical cut-off element and/or the at least one second mechanical cut-off element comprises a sectioning piston.

When activated, the sectioning piston is movable in translation so as to cut or section the conductive element. The sectioning piston can be activated by a detonation or deflagration of the pyrotechnic charge powered by the initiator element.

In some examples, the at least one main electrical protection element has a service voltage corresponding to half the voltage of the electrical supply that is applied to the electric charge.

Thus, the main electrical protection element is not configured to cut an electrical link between the electrical supply and the upstream point of the section to be protected. The main electrical protection element only makes it possible to create an electric arc that will trigger the initiator elements. Since the main electrical protection element cannot be sized to cut the conductive element, the main electrical protection element has a reduced size allowing easier physical integration of the main electrical protection element in the aircraft.

In some examples, the at least one main electrical protection element is a fuse.

In some examples, the electrical circuit comprises at least one first adjustment resistor electrically positioned in series with the first initiator element and/or at least one second adjustment resistor electrically positioned in series with the second initiator element.

The adjustment resistor makes it possible to limit a value of the current flowing in the initiator element.

In certain examples, the electrical circuit comprises at least one distribution box provided with at least one switching element.

The distribution box comprises at least one switching element, for example a contactor, making it possible to switch on or off the conductive element and therefore ultimately the electric charge.

Another aspect of the present disclosure concerns an aircraft comprising an electric charge powered by an electrical circuit according to the present disclosure.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic representation of an electrical circuit according to the present disclosure;

FIG. 2 is the schematic representation of the electrical circuit of FIG. 1 in which an electrical fault appears at the level of a conductive element;

FIG. 3 is the schematic representation of the electrical circuit of FIG. 2 in which a main electrical protection element goes into a triggered state;

FIG. 4 is the schematic representation of the electrical circuit of FIG. 3 in which an electric arc appears at the main electrical protection element;

FIG. 5 is the schematic representation of the electrical circuit of FIG. 4 in which a first pyrotechnic switch and a second pyrotechnic switch go into an open state;

FIG. 6 is the schematic representation of the electrical circuit of FIG. 5 in which a section of the conductive element is electrically isolated;

FIG. 7 is the schematic representation of a pyrotechnic switch of the electrical circuit of FIG. 1 in the closed state; and

FIG. 8 is the schematic representation of the pyrotechnic switch of FIG. 7 in the open state.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

In the remainder of the description, the upstream and the downstream are defined relative to a normal supply direction of the electric charge (from upstream to downstream), that is to say from an electrical supply HV−, HV+ to an electric charge 31.

To facilitate reading the drawings, the same elements bear the same references from one figure to the other.

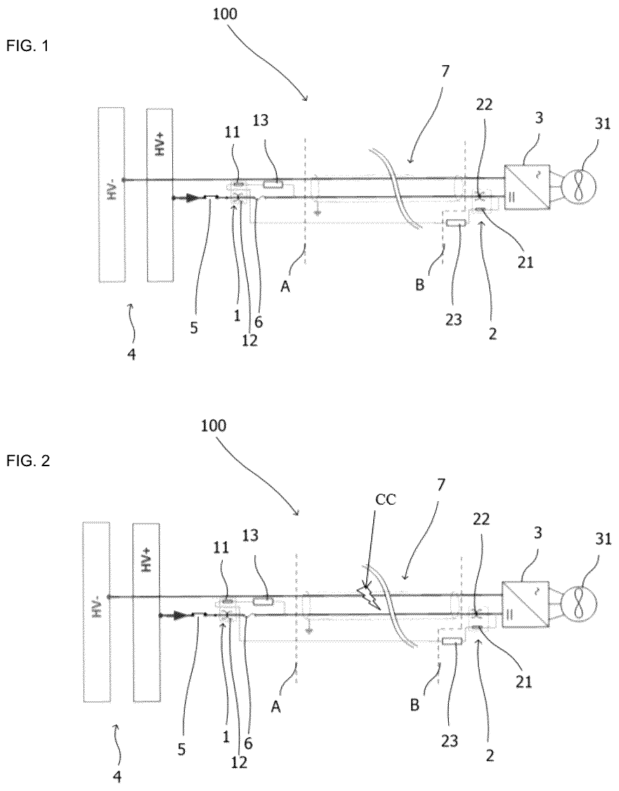

FIG. 1 relates to a schematic representation of an electrical circuit 100 according to the present disclosure. The electrical circuit 100 comprises a high-voltage HV−, HV+ electrical supply 4 which is an element that supplies electrical energy to the electrical circuit 100. The electrical supply 4 comprises an electrical generator such as a battery, for example, which supplies a high-voltage direct current, for example greater than 800V.

The electrical circuit 100 comprises an electric charge 31 which corresponds to an electricity consuming device in normal operation. In FIG. 1, the electric charge 31 is an electric propulsion comprising an electric motor 31 coupled to an inverter 3 which transforms the high voltage direct electric current into an alternating current.

The electric current flows between the power supply 4 and the electric charge 31 by means of a conductive element 7. The conductive element 7 comprises a section to be protected A-B during the occurrence of a DC electrical fault, for example of the short circuit type. In other words, this is the section A-B that must be electrically isolated following the appearance of the electrical fault CC in the section A-B as illustrated in FIG. 2. The section A-B is comprised between an upstream point A and a downstream point B.

In the example illustrated in FIG. 1, the electrical circuit 100 comprises a distribution box provided with a switching element 5, for example a contactor, making it possible to switch on or off the conductive element 7 and therefore ultimately the electric charge 31.

The electrical circuit 100 comprises a main electrical protection element 6 positioned between the power supply 4 and the upstream point of the section to be protected A-B. The main electrical protection element 4 is configured, in an engaged state, to pass the electrical current allowing to electrically supply the electric charge 31, and to be in a triggered state when the electrical fault CC occurs in the section to be protected A-B of the conductive element 7. The main electrical protection element 4 is in the triggered state when the electrical current at its terminals is greater than a maximum electrical current.

The engaged state is the state of the main electrical protection element 6 during normal operation of the electrical circuit 100. The main electrical protection element 6 is positioned between the power supply 4 and the upstream point A of the section to be protected A-B, such that the main electrical protection element 6 is subjected to the short-circuit current when the electrical fault CC occurs in the section to be protected A-B of the conductive element 7.

In some examples, the main electrical protection element 6 has a cut-off capacity lower than a value of a short-circuit current. Thus, the main electrical protection element 6 is not configured to cut an electrical link between the power supply 4 and the upstream point A of the section to be protected A-B. The main electrical protection element 6 only allows an electric arc 61 to be created which will trigger pyrotechnic switches 1, 2. Since the main electrical protection element 6 does not have to be sized to cut the conductive element 7, the main electrical protection element 6 has a reduced size allowing easier physical integration of the main electrical protection element 6 in an aircraft.

In the example of FIG. 1, the main electrical protection element 6 is a fuse.

The electrical circuit 100 also comprises a first pyrotechnic switch 1 provided with a first initiator element 11 and a first mechanical cut-off element 12 which is configured to perform an electrical cut-off of the conductive element 7 between the electrical power supply 4 and the upstream point A of the section to be protected A-B, and a second pyrotechnic switch 2 provided with a second initiator element 21 and a second mechanical cut-off element 22 which is configured to perform an electrical cut-off of the conductive element 7 between a downstream point B of the section to be protected A-B and the electric charge 31.

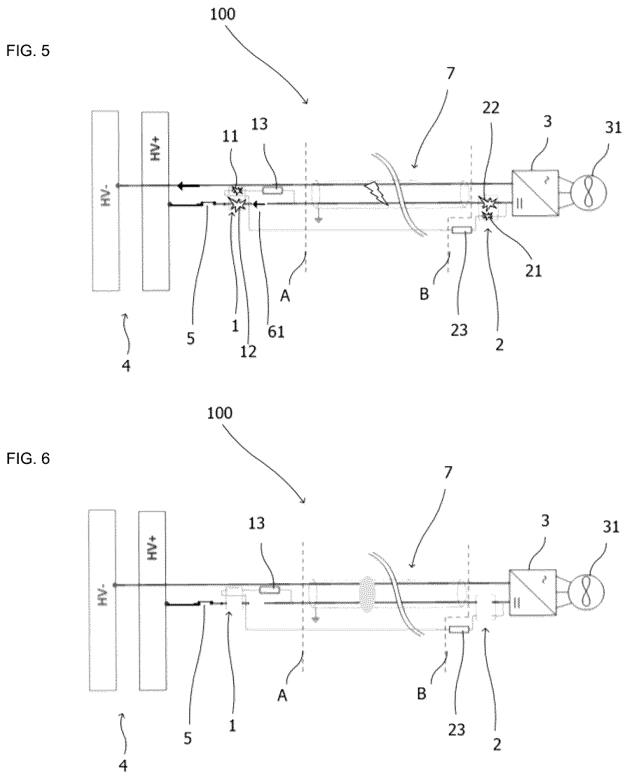

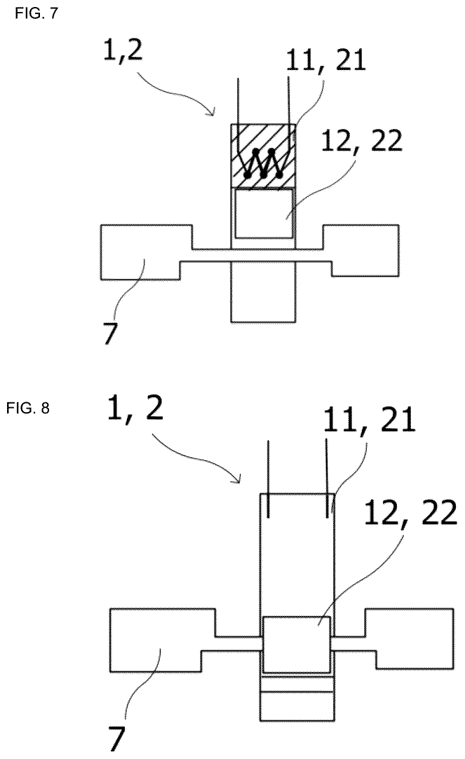

The pyrotechnic switches 1, 2 may be in a closed state, as in FIGS. 1 to 4 and 7, in which they allow the electric current to pass through the conductive element 7, or in an open state, as in FIGS. 5, 6 and 8, in which the electric current can no longer pass through the conductive element 7. The closed state is the state of the pyrotechnic switches 1, 2 during normal operation of the electrical circuit 100. The pyrotechnic switches 1, 2 are in an open state only when the DC electrical fault occurs. The pyrotechnic switches 1, 2 will be more precisely described with reference to FIGS. 7 and 8.

The pyrotechnic switches 1, 2 each comprise an initiator element 11, 21 and a mechanical cut-off element 12, 22.

In the example of FIG. 7, the initiator element 11, 21 comprises at least one electrical resistor surrounded by a pyrotechnic powder or liquid.

The initiator element 11, 21 is in a nominal state, as illustrated in FIG. 7, as long as an electrical voltage at its terminals is lower than a triggering voltage. The nominal state is the state of the initiator element 11, 21 during normal operation of the electrical circuit 100. The initiator element 11, 21 is in a triggered state, as illustrated in FIG. 8, when the voltage across its terminals has become greater than or equal to the triggering voltage for at least one instant, such as when the DC electrical fault occurs. A certain duration, called the trigger response time, is predefined for the initiator element 11, 21 to transition from the nominal state to the triggered state.

In some examples, a response time of a trigger of the first 11 and the second 21 initiator elements are identical. In some examples, the triggering voltage of the first initiator element 11 is equal to the triggering voltage of the second initiator element 21.

Thus, when the initiator element 11, 21 receives a voltage greater than or equal to the triggering voltage at its terminals, the initiator element 11, 21, here an electrical resistor, heats up, which actuates the pyrotechnic powder or liquid.

The first initiator element 11 and the second initiator element 21 are each electrically positioned in parallel with the main electrical protection element 6.

In the example illustrated in FIG. 1, the electrical circuit 100 comprises a first adjustment resistor 13 electrically positioned in series with the first initiator element 11 and a second adjustment resistor 23 electrically positioned in series with the second initiator element 21.

The adjustment resistors 13, 23 make it possible to limit a value of the current flowing in the initiator element 11, 21.

The mechanical cut-off element 12, 22 is a movable element configured to electrically cut-off the conductive element 7. In the example illustrated in FIGS. 7, 8, the mechanical cut-off element 12, 22 comprises a sectioning piston.

When the mechanical cut-off element 12, 22 is activated, as in FIG. 8, the sectioning piston, movable in translation, cuts or sections the conductive element 7. The sectioning piston can be activated by a detonation or a deflagration of the initiator element 11, 21.

The mechanical cut-off element 12, 22 can be in a nominal state or in an actuated state. The nominal state, illustrated in FIGS. 1 to 3, and 7, is the state of the mechanical cut-off element 12, 22 during normal operation of the electrical circuit 100. The mechanical cut-off element 12, 22 is in an actuated state, as illustrated in FIGS. 5, 6 and 8 when the initiator element 11, 21 has passed into a triggered state. A certain duration, called mechanical response time, is predefined for the mechanical cut-off element 12, 22 to change from the nominal state to the actuated state. The mechanical cut-off element 12, 22 cuts the conductive element 7 at the positioning of the pyrotechnic switch 1, 2. Since the first mechanical cut-off element 12 cuts the conductive element 7 between the power supply 4 and the upstream point A of the section to be protected A-B, the first pyrotechnic switch 1 is positioned between the power supply 4 and the upstream point A of the section to be protected A-B, and since the second mechanical cut-off element 22 cuts the conductive element 7 between the downstream point B of the section to be protected A-B and the electric charge 31, the second pyrotechnic switch 2 is positioned between the downstream point B of the section to be protected A-B and the electric charge B. The first switch 1 and the second switch 2 are mechanically positioned in series along the conductive element 7. This electrical positioning makes it possible to increase the cut-off capacity of each pyrotechnic switch 1, 2 so that the first pyrotechnic switch 1 and the second pyrotechnic switch 2 can be dimensioned with an operating voltage corresponding to half the voltage of the power supply that is applied to the electric charge 31.

In some examples, the mechanical response time of the at least one first 12 and the at least one second 22 mechanical cut-off elements are identical.

When the initiator element 11, 21 is in the nominal state, the mechanical cut-off element 12, 22 is also in the nominal state and the pyrotechnic switch 1, 2 is in the closed state.

When the initiator element 11, 21 is in the triggered state, the mechanical cut-off element 12, 22 is in the actuated state and the pyrotechnic switch 1, 2 is in the open state.

As described above, the pyrotechnic switches 1, 2 are positioned in the open state when the voltage across the initiator element 11, 21 has become greater than or equal to the triggering voltage.

An operation of the pyrotechnic switches 1, 2 when a DC electrical fault occurs will be described with reference to FIGS. 1 to 6.

FIG. 1 illustrates a normal operation of the electrical circuit 100 according to the present disclosure, in which the power supply 4 supplies the electric charge 31. During normal operation, the switching element 5 is in a closed state so as to pass the electric current into the conductive element 7. Furthermore, the first pyrotechnic switch 1 and the second pyrotechnic switch 2 are in a closed state, and the main protection element 6 is in an engaged state.

FIG. 2 illustrates the occurrence of the DC electrical fault in the conductive element 7, and more precisely in the section to be protected A-B of the conductive element 7.

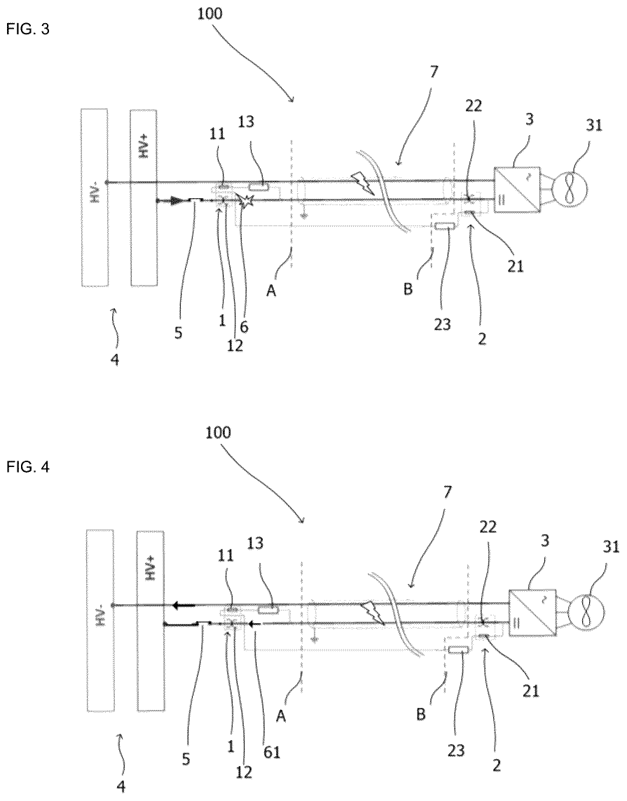

The DC electrical fault causes an increase in the electrical current flowing in the conductive element 7 so as to at least reach the value of the maximum electrical current of the main electrical protection element 6 and to cause the main electrical protection element 6 to switch to the triggered state as illustrated in FIG. 3.

The switch to the triggered state of the main electrical protection element 6 causes the formation of an electric arc 61 between its terminals as illustrated in FIG. 4.

The electric arc 61 causes a voltage at the terminals of the first initiator element 11 and the second initiator element 21, which are each electrically positioned in parallel with the main electrical protection element 6, greater than or equal to the triggering voltage of the first initiator element 11 and the second initiator element 21. Thus the first initiator element 11 and the second initiator element 21 switches to the triggered state, causing the first 12 and second 22 mechanical cut-off elements to switch to the actuated state, and therefore finally the two pyrotechnic switches 1, 2 to switch to the open state, as illustrated in FIG. 5.

Finally, the first pyrotechnic switch 1 and the second 2 pyrotechnic switched are therefore in the open state, as illustrated in FIG. 6. The section A-B of the conductive element 7 is therefore electrically separated from the electrical circuit 100, the DC electrical fault is therefore also isolated. There is no longer any possibility of re-supplying the DC electrical fault by the electric charge 31, that is to say even in the event of a windmilling effect.

In certain examples, a response time of a triggering of the at least one first initiator element 11 and the at least one second initiator element 21 is less than a mechanical response time of the at least one first 12 and the at least one second 22 mechanical cut-off elements. Thus, when the electric arc 61 forms across the main electrical protection element 6, even if the first initiator element 11 receives the triggering voltage slightly before the second initiator element 21, the first mechanical cut-off element 12 does not switch to the actuated state until the second initiator element 21 has received the triggering voltage. Thus, both initiator elements 11, 21 are triggered before one of the mechanical cut-off elements 12, 22 switches to the actuated state.

Although the present disclosure has been described with reference to specific examples, it is obvious that modifications and changes may be made to these examples without departing from the general scope of the present disclosure as defined by the claims. In particular, individual characteristics of the various illustrated/mentioned examples may be combined in additional examples. Therefore, the description and drawings should be considered in an illustrative rather than restrictive sense.

It is also obvious that all the characteristics described with reference to a method are transposable, alone or in combination, to a device, and conversely, all the characteristics described with reference to a device are transposable, alone or in combination, to a method.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. An electrical circuit for supplying at least one electric charge of an aircraft, the electrical circuit comprising:
at least one electrical power supply electrically connected to the at least one electric charge by at least one conductive element;
at least one main electrical protection element positioned between the at least one electrical power supply and an upstream point of a section of the at least one conductive element to be protected during an occurrence of an electrical fault;
at least one first pyrotechnic switch provided with at least one first initiator element and at least one first mechanical cut-off element configured to electrically cut-off the at least one conductive element between the at least one electrical power supply and the upstream point of the section to be protected; and
at least one second pyrotechnic switch provided with at least one second initiator element and at least one second mechanical cut-off element configured to electrically cut-off the at least one conductive element between a downstream point of the section to be protected and the at least one electric charge,
wherein the at least one first initiator element and the at least one second initiator element are each electrically positioned in parallel with the at least one main electrical protection element.

2. The electrical circuit according to claim 1, wherein a response time of a triggering of the at least one first initiator element and the at least one second initiator element is less than a mechanical response time of the at least one first mechanical cut-off element and the at least one second mechanical cut-off element.

3. The electrical circuit according to claim 1, wherein at least one of the at least one first initiator element and the at least one second initiator element comprises at least one electrical resistor surrounded by a pyrotechnic powder or liquid.

4. The electrical circuit according to claim 1, wherein at least one of the at least one first mechanical cut-off element and the at least one second mechanical cut-off element comprises a sectioning piston.

5. The electrical circuit according to claim 1, wherein the at least one main electrical protection element has an operating voltage corresponding to half a voltage of the at least one electrical power supply that is applied to the at least one electric charge.

6. The electrical circuit according to claim 1, further comprising at least one first adjustment resistor electrically positioned in series with the at least one first initiator element.

7. The electrical circuit according to claim 1, further comprising at least one second adjustment resistor electrically positioned in series with the at least one second initiator element.

8. The electrical circuit according to claim 1, further comprising at least one distribution box provided with at least one switching element.

9. An aircraft comprising the at least one electric charge powered by the electrical circuit according to claim 1.
